(19) United States
(12) Patent Application Publication
(10) Pub. No.: US 2012/0299722 A1
(43) Pub. Date: Nov. 29, 2012

(54) MONITORING SYSTEM AND METHOD OF USING SAME

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/220,711

(22) Filed: Aug. 30, 2011

(30) Foreign Application Priority Data
May 24, 2011 (TW) 100118198

(51) Int. Cl. G08B 1/08

(52) U.S. Cl. 340/539.12

(57) ABSTRACT

A monitoring system includes electronic monitoring equipment, a computing system, and a terminal device. The electronic monitoring equipment is worn/fastened on a monitored subject, and monitors certain relevant parameters of the subject. The computing system determines whether the subject is likely to do any forbidden activities according to the parameters applied. The computing system warns a monitor who may investigate and stop a forbidden activity. The terminal device determines whether with the subject wearing the monitoring equipment is within a specified distance of the terminal device.

### BACKGROUND

1. Technical Field

Embodiments of the present disclosure relate to monitoring systems, and more particularly to a monitoring system for the electronic monitoring of equipment and method of using the same.

2. Description of Related Art

Electronic monitoring equipment may be configured to monitor specified subjects, such as prisoners, for example. But an electronic monitoring device is only capable of monitoring during a specified time period, such as night time. If the monitored prisoner does or tries to do something forbidden outside the specified time period, the monitor cannot learn of this in time. In addition, the monitoring equipment can only inform a monitoring organization about planned or potential activities which may be forbidden. In this situation, people who live in an area with a high-crime can not know about potential danger from the planned or potential activities. What is needed, therefore, is a system and method to overcome the aforementioned problems.

### BRIEF DESCRIPTION OF THE DRAWINGS

FIG. 1 is a schematic diagram of an exemplary embodiment of a monitoring system.

FIG. 2 is a block diagram of an exemplary embodiment of the monitoring system of FIG. 1.

FIGS. 3A-3B show a flowchart illustrating an exemplary embodiment of a method of using the monitoring system of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of detect module instructions, written in a programming language, such as, for example, Java, C, or in assembly. One or more detect module instructions in the module may be embedded in firmware, such as in an EPROM. It will be appreciated that a module may comprise connected logic units, such as gates and flip-flops, and may comprise programmable units, such as programmable gate arrays or processors. The modules described herein may be implemented as either detect module and/or hardware module and may be stored in any type of computing system-readable medium or other computing system storage device.

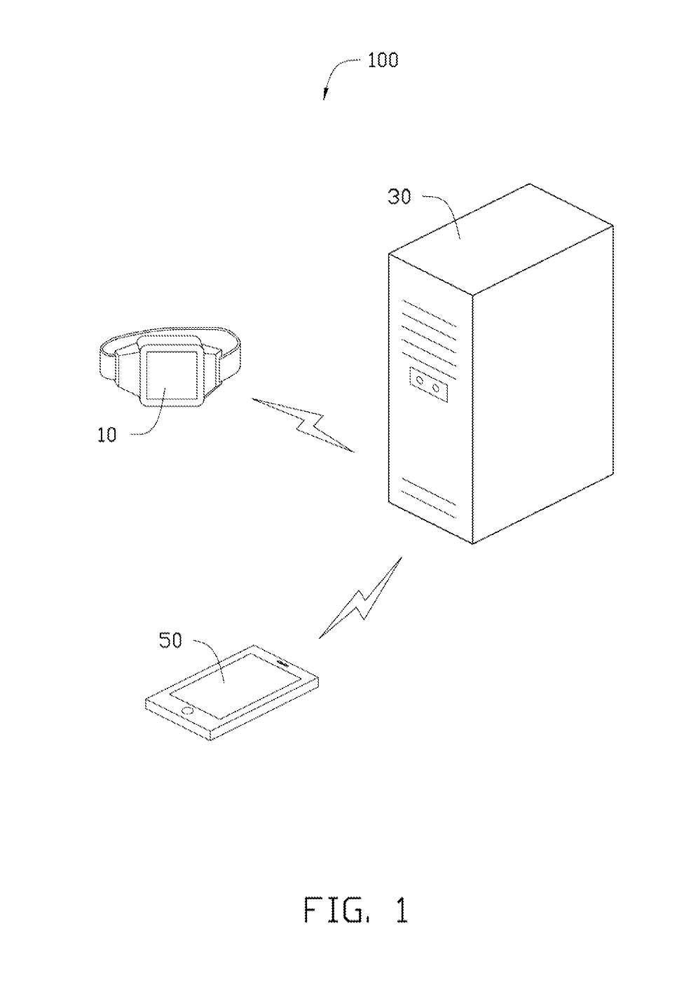

FIG. 1 shows an exemplary embodiment of a monitoring system 100 used in an electronic monitoring equipment 10. The equipment 10 is configured to monitor special subjects/objects whose freedom is partially restricted, such as probationers, parolees, persons living under surveillance, pets, animals in the zoo, or any other life-forms. In the following embodiments, for simplicity, the monitoring system 100 is configured to monitor human prisoners subject to surveillance.

The electronic monitoring equipment 10 is structured to be worn or fastened to a leg, arm, or clothes of a monitored prisoner. The electronic monitoring equipment 10 is configured to measure certain parameters of the prisoner, such as his location, and certain physiological parameters of the prisoner, such as heartbeat, pulse, blood pressure, temperature, or any other physiological parameter. The electronic monitoring equipment 10 is capable of sending information concerning these parameters to a computing system 30. The computing system 30 is capable of judging the behavior of the prisoner, and likely future behavior, in accordance with the parameters applied, and send a warning to the monitoring organization, such as policemen, for example. A terminal device 50 can be issued to communicate with the monitoring system 100, so that users with the terminal device 50 may be warned of potentially dangerous behavior on the part of a prisoner via the terminal device 50, for example when a prisoner with the electronic monitoring equipment 10 shows up within a specified distance of the terminal device 50. Examples of terminal devices 50 are given below.

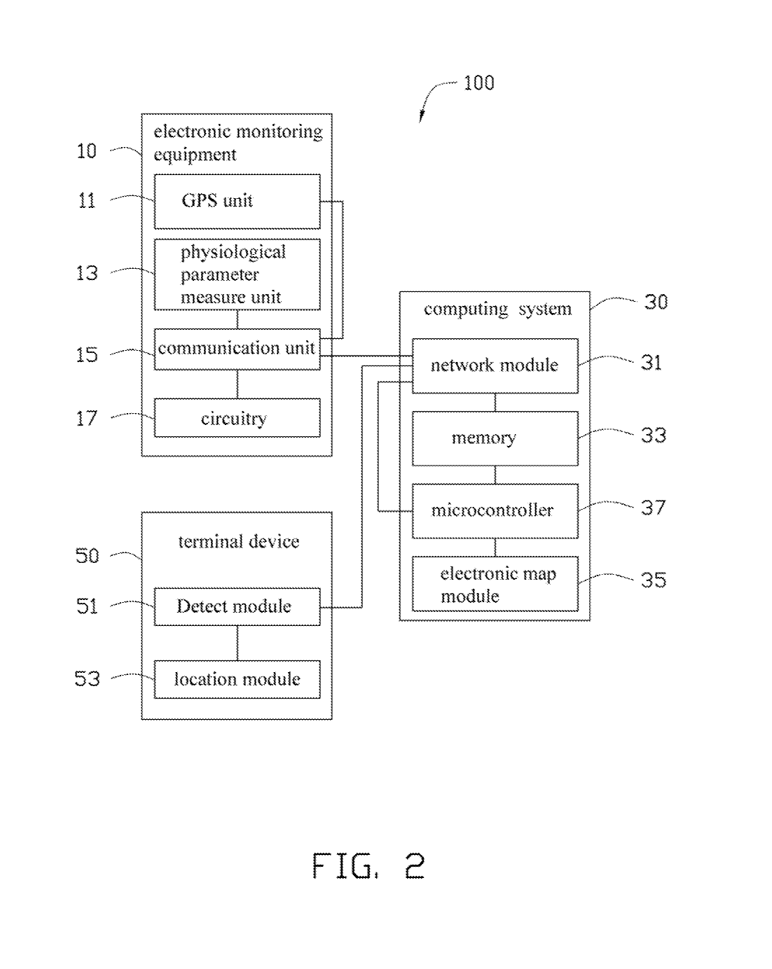

Also referring to the FIG. 2, the electronic monitoring equipment 10 includes a global positioning system (GPS) unit 11, a physiological parameter measuring unit 13, and a communication unit 15. The GPS unit 11 is configured to locate the prisoner through GPS tracking. The physiological parameter measuring unit 13 is a physical device/tool that can measure the heartbeat, pulse, blood pressure, temperature, or other physiological parameters of the prisoner in this embodiment. The communication unit 15 wirelessly communicates with the compute 30 via a wireless network, and is configured to send data concerning the parameters from the GPS unit 11 and the measuring unit 13 to the computing system 30 via the wireless network.

In this exemplary embodiment, the equipment 10 is an ankle bracelet configured to be worn by the prisoner, which can not be disengaged by the prisoner. The equipment 10 further includes circuitry 17 electrically connected to the communication unit 15. The communication unit 15 is capable of sending a warning signal to the computing system 30, when the circuitry 17 is damaged, so the monitor can be warned of a probable attempt by the prisoner to escape the monitoring.

The computing system 30 includes a network module 31, a memory 33, an electronic map module 35, and a microcontroller 37. The network module 31 is configured to wirelessly communicate with the equipment 10 and the terminal device 50 over a wireless network, and receives the location and psychological parameters from the equipment 10. The memory 33 (e.g., flash memory) is configured to store the location and psychological parameters from the equipment 10, and prisoner information. The prisoner information may be a list of the prisoners with the electronic monitoring equipment, the permitted geographical areas of each prisoner, the crime(s) of each prisoner, and some other predetermined parameters relevant to the prisoner. The microcontroller 37 is capable of setting the permitted geographical area for each prisoner in the electronic map module 35 and can evaluate the location and psychological parameters monitored by the monitoring equipment 10 and the predetermined parameters of the subject, and send a warning to a monitoring organization in response to the evaluation. In detail, the microcontroller 37 determines whether a prisoner(s) is outside or in the process of going outside his permitted geographical area according to the current position from the GPS unit 11 and the permitted geographical area of each prisoner. The microcontroller 37 is capable of determining whether the physiological parameters of a prisoner is changing or has changed abnormally, and issue an appropriate warning to the monitoring organization according to the determining.

The terminal device 50 is either a portable electronic device, such as a mobile phone, for example, or an item of communications equipment which may be mounted in all kinds of locations, such as house, schools, and hospitals, for example. The terminal device 50 can be authorized to communicate in both directions with the computing system 30 and includes a detect module 51 and a location module 53. The location module 53 determines the location of the terminal device 50, and sends this information to the detect module 51. The detect module 51 is capable of accessing the memory 33 to detect whether there are any prisoners showing up within a specified distance of the terminal device 50. And the terminal device 50 may warn the user of potential danger from a prisoner(s) showing up. Furthermore, the terminal device 50 can communicate with the microcontroller 37. When the detect module 51 detects that there are prisoners moving around a house or any other public location after a given curfew, or other specified latest time, or for a period of time which is longer than specified or expected, the detect module 51 issues a notice accordingly to the microcontroller 37, so the microcontroller 37 can send a warning to the monitoring organization about the prisoner.

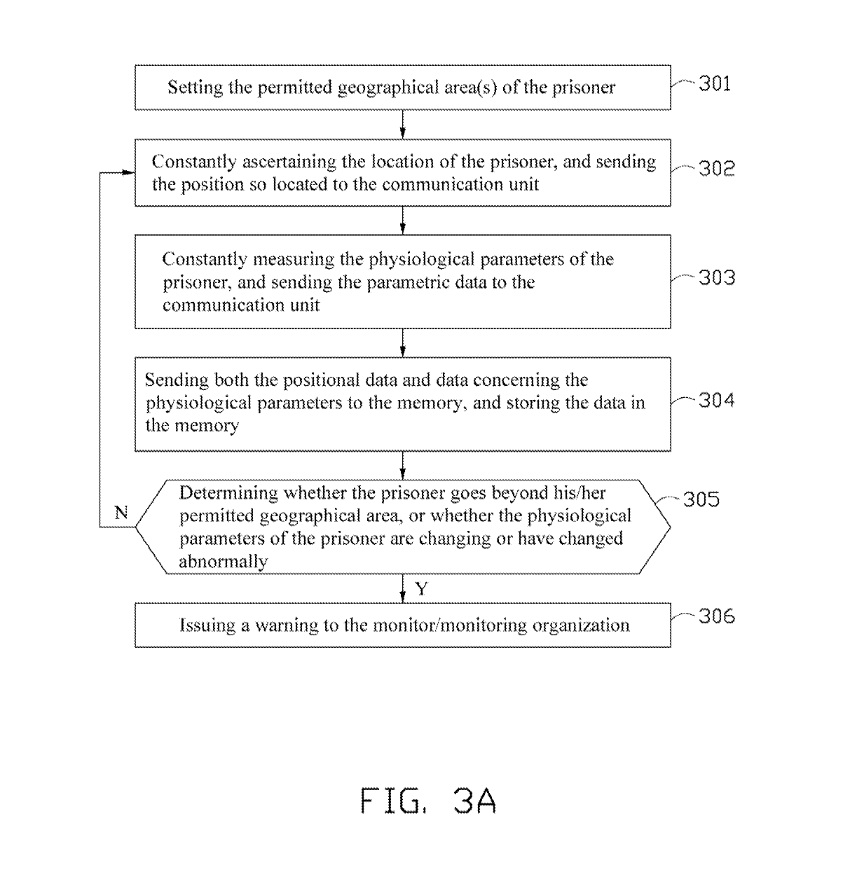

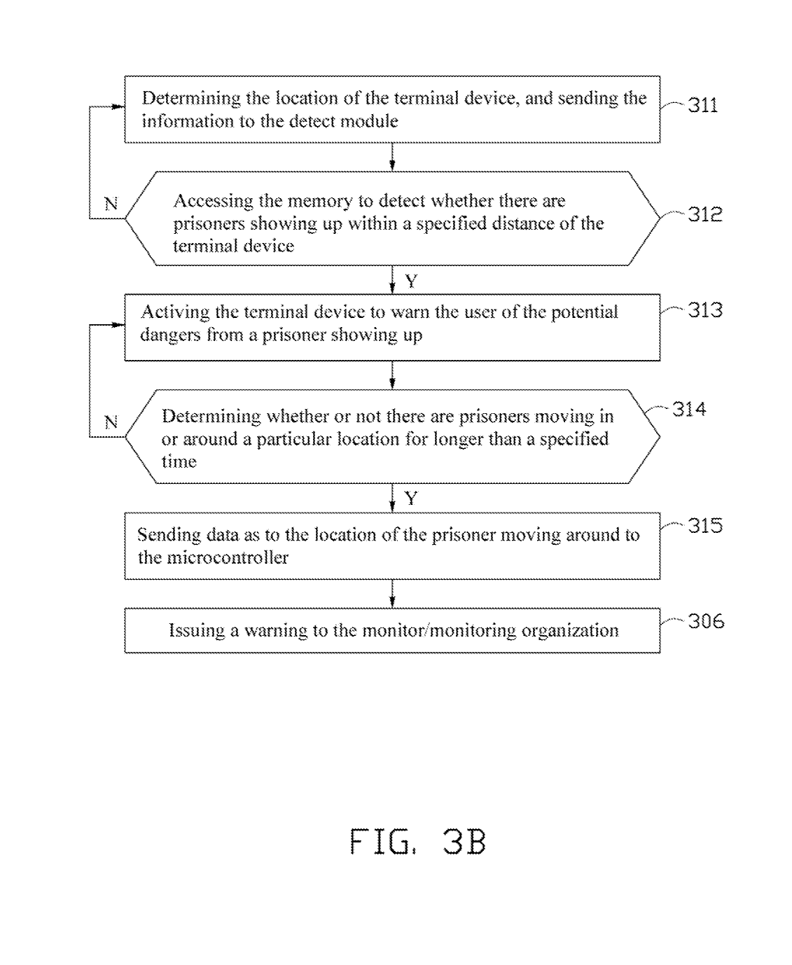

FIG. 3A and FIG. 3B are flowcharts illustrating an exemplary embodiment of a method of using the monitoring system 100. In the flowcharts, it is assumed that the equipment 10 is worn on or by a prisoner. Depending on the embodiment, certain of the blocks described may be removed, others may be added, and the sequence of the blocks may be altered. The description and the claims drawn for a method may include some indication in reference to certain steps, however, the indication used is only to be viewed for identification purposes and not as a suggestion as to an order for the blocks.

In block 301, the microcontroller 37 sets the permitted geographical area(s) of the prisoner.

In block 302, the GPS unit 11 constantly ascertains the location of the prisoner, and sends the position so located to the communication unit 15.

In block 303, the measuring unit 13 constantly measures the physiological parameters of the prisoner, and sends the parametric data to the communication unit 15.

In block 304, the communication unit 15 sends both the positional data and data concerning the physiological parameters to the memory 33, and stores the data in the memory 33.

In block 305, the microcontroller 37 determines whether the prisoner goes beyond his/her permitted geographical area, or whether the physiological parameters of the prisoner are changing or have changed abnormally. If any such event occurs, block 306 is implemented. If such events have not occurred, the process returns to the block 302.

In block 306, the microcontroller 37 issues a warning to the monitoring organization, so the monitoring organization can investigate the prisoner more particularly.

In block 311, the location module 53 determines the location of the terminal device 50, and sends the information to the detect module 51.

In block 312, the detect module 51 accesses the memory 33 to detect whether there are prisoners showing up within a specified distance of the terminal device 50. If any such event occurs, block 313 is implemented. If such events have not occurred, the process returns to the block 311.

In block 313, the detect module 51 actives the terminal device 50 to warn the user of the potential dangers from a prisoner showing up.

In block 314, the detect module 51 determines whether or not there are prisoners with equipment 10 moving in or around a particular location for longer than a specified time. If any such event occurs, block 315 is implemented. If such events have not occurred, the process returns to the block 313.

In block 315, the detect module 51 sends data as to the location of the prisoner moving around to the microcontroller 37, thereafter the process goes to the block 307.

In the exemplary embodiment, the monitoring system 100 determines whether the subject with the electronic monitoring equipment 10 is likely to do something forbidden, according to either his/her/its location and/or his physiological parameters, so that the monitoring organization can investigate and stop the forbidden activity in time. In addition, the terminal device 50 can be authorized to communicate in both directions with the computing system 30, to learn about any potential danger in time, so a user of the terminal device 50 can avoid a potential danger, or even further become prepared to fight off the danger if necessary. The system 100 has a better monitoring effectiveness, and inhabitants live in a high-crime area can know about potential danger in time.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computing system configured to communicate with an electronic monitoring equipment, the monitoring equipment structured to be worn on a subject and configured to monitor location and psychological parameters of the subject, the computing system comprising:
a network module configured to communicate with the electronic monitoring equipment over a wireless network and receive the location and psychological parameters via the wireless network;
a memory configured to store the location and psychological parameters, and predetermined parameters of the subject; and
a microcontroller configured to evaluate the location and psychological parameters monitored by the monitoring equipment and the predetermined parameters of the subject, and send a warning to a monitoring organization in response to the evaluation.

2. The computing system of claim 1, wherein the microcontroller receives the position of the subject from a global positioning system (GPS) unit of the electronic monitoring equipment, and determines whether the subject is likely to escape according to the located position and permitted geographical area of the subject.

3. The computing system of claim 1, wherein the microcontroller receives the physiological parameters of the subject from a physiological parameter measuring unit of the electronic monitoring equipment, and determines whether the subject is likely to cause harm according to whether the monitored parameters of the subject changes abnormally.

4. The computing system of claim 1, wherein the electronic monitoring equipment further comprises circuitry, the microcontroller is configured to warn monitoring organization, in response to damage to the circuitry.

5. A computing system configured to communicate with an electronic monitoring equipment and a terminal device, the monitoring equipment structured to be worn on a subject and configured to monitor location and psychological parameters of the subject, the computing system comprising:
a network module configured to communicate with both the terminal device and the electronic monitoring equipment over a wireless network and receive the location and psychological parameters via the wireless network;
a memory configured to store the location and psychological parameters, and predetermined parameters of the subject; and
a microcontroller configured to evaluate the location and psychological parameters monitored by the monitoring equipment and the predetermined parameters of the subject, and send a warning to a monitoring organization in response to the evaluation.

6. The computing system of claim 5, wherein the microcontroller receives the position of the subject from a global positioning system (GPS) unit of the electronic monitoring equipment, and determines whether the subject is likely to escape according to the located position and permitted geographical area of the subject.

7. The computing system of claim 5, wherein the microcontroller receives the physiological parameters of the subject from a physiological parameter measuring unit of the electronic monitoring equipment, and determines whether the subject is likely to cause harm according to whether the monitored parameters of the subject changes abnormally.

8. The computing system of claim 5, wherein the electronic monitoring equipment further comprises circuitry, the microcontroller is configured to warn monitoring organization, in response to damage to the circuitry.

9. The computing system of claim 5, wherein the warning signal is sent to the monitoring organization if the subject is around a specific location exceeding a specified time.

10. A method of monitoring a subject by a computing system communicating with an electronic monitoring equipment and a terminal device, the electronic monitoring equipment comprising a global positioning system (GPS) unit and a physiological parameter measuring unit, the method comprising:
determining a location of the subject by the GPS unit of the electronic monitoring equipment;
measuring physiological parameters of the subject by the physiological parameter measuring unit;
determining whether the subject is likely to do a forbidden activity according to the position and/or physiological parameters information of the subject;
in response to the subject being likely to do the forbidden activity, issuing a warning to a monitoring organization;
determining whether there a subject is in range of a predetermined distance of a terminal device; and issuing a warning to a user of the terminal device.

11. The method of claim 10, further comprising sending a warning signal to the monitoring organization if the subject is around a specific location exceeding a specified time.

12. The method of claim 10, further comprising setting a permitted geographical area for the subject before the step of determining whether the subject is likely to do the forbidden activity.
